(19) United States
(12) Patent Application Publication
(10) Pub. No.: US 2026/0178478 A1
(43) Pub. Date: Jun. 25, 2026

(54) VOLATILE MEMORY RESOURCE SHARING IN A MEMORY SYSTEM

(71) Applicant: SK Hynix NAND Product Solutions Corp. (dba Solidigm), Rancho Cordova, CA (US)

(72) Inventor: Samuel BRADSHAW, Sacramento, CA (US)

(21) Appl. No.: 19/000,068

(22) Filed: Dec. 23, 2024

(51) Int. Cl. G06F 12/02; G06F 12/0811; G06F 12/0846

(52) U.S. Cl. CPC G06F 12/0246; G06F 12/0811; G06F 12/0848

(57) ABSTRACT

This application is directed to managing memory resources in a memory device. The memory device allocates two distinct sets of processor cores to perform memory access and management functions of a memory controller and in-memory data processing functions of a data processor. A volatile memory is partitioned to a first memory portion and a second memory portion. The first memory portion is configured to store address mapping data for the memory controller temporarily, and the second memory portion is configured to store payload data for the data processor temporarily. A caching request is received from the data processor for temporarily storing target data. In response to the caching request and in accordance with a determination that the second memory portion associated with the data processor has insufficient memory space to store the target data, the memory device stores the target data in the first memory portion via the memory controller.

### TECHNICAL FIELD

This application relates generally to data memory device including, but not limited to, methods, systems, and devices for managing local volatile memory resources to implement memory operations and in-memory data processing operations in a memory system.

### BACKGROUND

Memory is applied in a computer system to store instructions and data. The data are processed by one or more processors of the computer system according to the instructions stored in the memory. Multiple memory units are used in different portions of the computer system to serve different functions. Specifically, the computer system includes non-volatile memory that acts as secondary memory to keep data stored thereon if the computer system is decoupled from a power source. Examples of the secondary memory include, but are not limited to, hard disk drives (HDDs) and solid-state drives (SSDs). The secondary memory relies on a memory controller to manage its memory space and process read, write, and read-modify-write requests from a host device efficiently with low latency. The secondary memory have been developed to integrate local in-memory data processing capabilities; however, these capabilities are often limited by the constrained processing and buffering resources available on the second memory, as well as the prioritization of memory management operations. The overall effectiveness of in-memory data processing may heavily rely on allocation of resources within the secondary memory.

### SUMMARY

Various embodiments of this application are directed to methods, memory systems, and memory devices for managing local volatile memory resources (e.g., random-access memory space) to implement memory operations and in-memory data processing operations. In some embodiments, a controller of a memory device (e.g., an SSD) is configured to manage data storage, data retrieval, and interfacing with a host. A memory device (also called a storage device) includes a plurality of processing cores, and is transformed to a computational storage device (CSD) by providing both a memory controller and a data processor using the plurality of processing cores. The data processor is configured to process internal computational storage functions (e.g., data processing operations) locally on the memory device, and the memory controller of the memory device is configured to perform generic memory functions including memory access functions (e.g., input/output (I/O) access operations) and internal memory management functions. In some embodiments, an address space may be statically allocated to either of the memory controller and the data processor at a boot time, and onboard random-access memory space of the CSD is dynamically shared by the generic memory functions of the memory controller and the data processing operations of the data processor. More specifically, in some embodiments, dynamic random-access memory (DRAM), static random-access memory (SRAM), or both are shared between a host-interfacing nonvolatile memory express (NVMe) firmware and an in-memory Linux compute environment in a memory device (e.g., an SSD), and the address space is statically allocated to each side at the boot time.

In one aspect, a method is implemented by a memory device to manage memory resources. The memory device has a plurality of processor cores, a volatile memory, and a non-volatile memory. The method includes allocating a first subset of processor cores to perform a plurality of memory access and management functions of a memory controller, allocating a second subset of processor cores to perform a plurality of in-memory data processing functions of as a data processor, partitioning the volatile memory to (1) a first memory portion for storing address mapping data temporarily for the memory controller and (2) a second memory portion for storing payload data temporarily for the data processor. The method further includes receiving, from the data processor, a caching request for storing target data temporarily. The method further includes, in response to the caching request and in accordance with a determination that the second memory portion associated with the data processor has insufficient memory space to store the target data, storing the target data in the first memory portion via the memory controller.

In some embodiments, the method further includes, in response to the caching request and in accordance with a determination that the second memory portion has insufficient memory space to store the target data, updating a mapping table associating a virtual address of the target data with a physical address in the first memory portion of the volatile memory.

In some embodiments, the plurality of processor cores are grouped into a plurality of clusters. The first subset of processor cores of the memory controller correspond to a first set of one or more clusters, and the second subset of processor cores of the data processor correspond to a second set of one or more clusters, and the memory controller and the data processor share a cluster-level L3 cache.

In some embodiments, the memory device is coupled to a host device. The method further includes, by the memory controller, receiving a host write request including first data and a logical address of the first data and determining that the first memory portion has insufficient memory space to store a first mapping entry translating the logical address of the first data to a physical address of the first data. The method further includes, in response to the host write request and in accordance with a determination that the first memory portion has insufficient memory space to store the first mapping entry, determining a physical address in the non-volatile memory for storing the first data, storing the first mapping entry in one of the second memory portion and the non-volatile memory, and storing the first data in the non-volatile memory based on the physical address of the first data.

In another aspect, a method is implemented by a memory device to manage memory resources. The memory device is coupled to a host device, and has a plurality of processor cores, a volatile memory, and a non-volatile memory. The method includes allocating a first subset of processor cores to perform a plurality of memory access and management functions of a memory controller, allocating a second subset of processor cores to perform a plurality of in-memory data processing functions of as a data processor, partitioning the volatile memory to (1) a first memory portion for storing address mapping data temporarily for the memory controller and (2) a second memory portion for storing payload data temporarily for the data processor. The method further includes, by the memory controller, receiving a host write request including first data and a logical address of the first data and determining that the first memory portion has insufficient memory space to store a first mapping entry translating the logical address of the first data to a physical address of the first data. The method further includes in response to the host write request, in accordance with a determination that the first memory portion has insufficient memory space to store the first mapping entry: determining a physical address in the non-volatile memory for storing the first data, storing the first mapping entry in one of the second memory portion and the non-volatile memory, and storing the first data in the non-volatile memory based on the physical address of the first data.

In another aspect, some implementations include a memory system or a memory device (e.g., SSDs) that includes a memory controller, a data processor distinct from the memory controller, a non-volatile memory coupled to the memory controller, and memory having instructions stored thereon for performing any of the above methods of managing memory resources (e.g., volatile memory space).

In yet another aspect, some implementations include a non-transitory computer readable storage medium storing one or more programs. The one or more programs include instructions, which when executed by a memory system (e.g., SSDs) or a memory device (e.g., a SSD) cause the memory system or the memory device to implement any of the above methods to manage memory resources (e.g., volatile memory space).

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a block diagram of an example system module in a typical electronic device in accordance with some embodiments.

FIG. 2 is a block diagram of a memory system of an example electronic device, in accordance with some embodiments.

FIG. 3 is a block diagram of an example electronic system that includes a memory system having an internal processing capability, in accordance with some embodiments.

FIG. 4 is a block diagram of an example computer system including a memory system that operates in compliance with a storage access and transport protocol, in accordance with some embodiments.

FIGS. 5A-5C are block diagrams of an example electronic system that uses a block namespace for storing and retrieving data based on memory pages, in accordance with some embodiments.

FIG. 6 is a block diagram of an example electronic system that shares volatile memory space to facilitate in-memory data processing in a memory device, in accordance with some embodiments.

FIG. 7 is a block diagram of an example electronic system that shares volatile memory space to facilitate storage functions of a memory device, in accordance with some embodiments.

FIG. 8 is a block diagram of an example electronic system that stores one or more page tables in a non-volatile memory in a memory device, in accordance with some embodiments.

FIG. 9 is a flow diagram of an example method for managing volatile memory space in a memory device 240, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with storage capabilities.

A computer system includes non-volatile memory that acts as secondary memory to keep data stored thereon if the computer system is decoupled from a power source. Examples of the secondary memory include, but are not limited to, hard disk drives (HDDs) and solid-state drives (SSDs). The secondary memory relies on a memory controller to manage its memory space and process read, write, and read-modify-write requests from a host device efficiently with low latency. In some embodiments, a memory device (also called a storage device) includes a plurality of processing cores, and is transformed to a CSD by configuring two subsets of processing cores to a memory controller and a data processor, respectively. The data processor is configured to process internal computational storage operations (e.g., data processing operations) locally on the memory device, while the memory controller of the memory device specializes in performing generic storage functions including memory access functions (e.g., input/output (I/O) access operations) and internal memory management functions. In accordance with some embodiments of this application is at least a realization that the CSDs applied in many edge applications (e.g., mobile phones) often operate with buffers (e.g., DRAM and SRAM) that have a limited size and a static partition scheme.

Further, in accordance with some embodiments of this application is at least a realization that there is a need to share buffer space between a memory controller and a data processor of a memory device using storage semantics. Some implementations of this application are directed to sharing volatile memory (e.g., DRAM and SRAM) between memory storage and compute functions dynamically, e.g., using established NVMe protocol semantics to share memory. The volatile memory is partitioned to a first memory portion for storing address mapping data temporarily for the memory controller and a second memory portion for storing payload data temporarily for the data processor. The data processor issues a caching request for storing target data temporarily. In response to the caching request and in accordance with a determination that the second memory portion associated with the data processor has insufficient memory space to store the target data, the data processor stores the target data in the first memory portion via the memory controller.

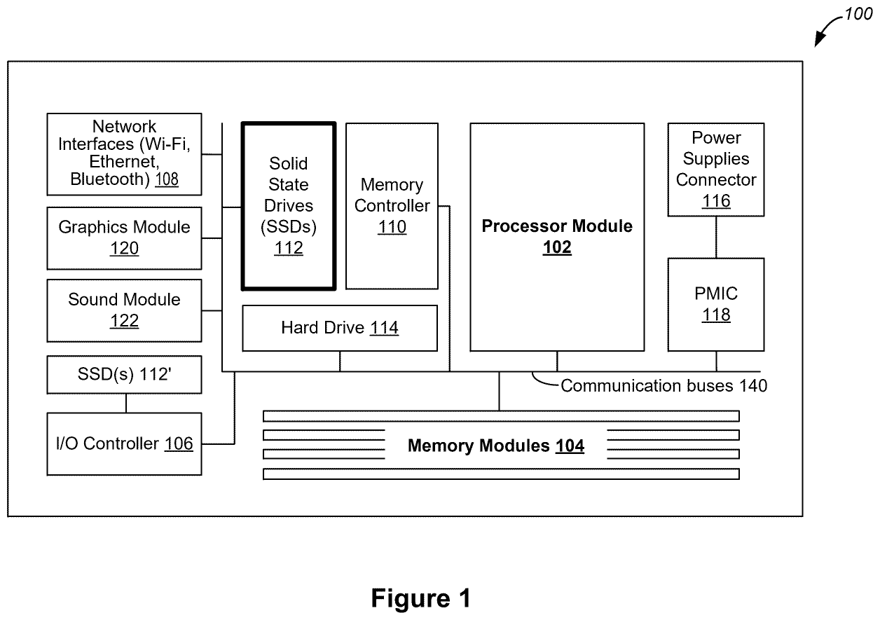

FIG. 1 is a block diagram of an example system module 100 in a typical electronic system in accordance with some embodiments. The system module 100 in this electronic system includes at least a processor module 102, memory modules 104 for storing programs, instructions and data, an input/output (I/O) controller 106, one or more communication interfaces such as network interfaces 108, and one or more communication buses 140 for interconnecting these components. In some embodiments, the I/O controller 106 allows the processor module 102 to communicate with an I/O device (e.g., a keyboard, a mouse or a trackpad) via a universal serial bus interface. In some embodiments, the network interfaces 108 includes one or more interfaces for Wi-Fi, Ethernet and Bluetooth networks, each allowing the electronic system to exchange data with an external source, e.g., a server or another electronic system. In some embodiments, the communication buses 140 include circuitry (sometimes called a chipset) that interconnects and controls communications among various system components included in system module 100.

In some embodiments, the memory modules 104 include high-speed random-access memory, such as static random-access memory (SRAM), double data rate (DDR) dynamic random-access memory (DRAM), or other random-access solid state memory devices. In some embodiments, the memory modules 104 include non-volatile memory, such as one or more magnetic disk storage devices, optical disk storage devices, flash storage devices, or other non-volatile solid state storage devices. In some embodiments, the memory modules 104, or alternatively the non-volatile storage device(s) within the memory modules 104, include a non-transitory computer readable storage medium. In some embodiments, memory slots are reserved on the system module 100 for receiving the memory modules 104. Once inserted into the memory slots, the memory modules 104 are integrated into the system module 100.

In some embodiments, the system module 100 further includes one or more components selected from a memory controller 110, SSD(s) 112, an HDD 114, power management integrated circuit (PMIC) 118, a graphics module 120, and a sound module 122. The memory controller 110 is configured to control communication between the processor module 102 and memory components, including the memory modules 104, in the electronic system. The SSD(s) 112 are configured to apply integrated circuit assemblies to store data in the electronic system, and in many embodiments, are based on NAND or NOR memory configurations. The HDD 114 is a conventional data memory device used for storing and retrieving digital information based on electromechanical magnetic disks. The power supply connector 116 is electrically coupled to receive an external power supply. The PMIC 118 is configured to modulate the received external power supply to other desired DC voltage levels, e.g., 5V, 3.3V or 1.8V, as required by various components or circuits (e.g., the processor module 102) within the electronic system. The graphics module 120 is configured to generate a feed of output images to one or more display devices according to their desirable image/video formats. The sound module 122 is configured to facilitate the input and output of audio signals to and from the electronic system under control of computer programs.

Alternatively or additionally, in some embodiments, the system module 100 further includes SSD(s) 112′ coupled to the I/O controller 106 directly. Conversely, the SSDs 112 are coupled to the communication buses 140. In an example, the communication buses 140 operates in compliance with Peripheral Component Interconnect Express (PCIe or PCI-E), which is a serial expansion bus standard for interconnecting the processor module 102 to, and controlling, one or more peripheral devices and various system components including components 110-122.

Further, one skilled in the art knows that other non-transitory computer readable storage media can be used, as new data storage technologies are developed for storing information in the non-transitory computer readable storage media in the memory modules 104, SSD(s) 112 or 112′, and HDD 114. These new non-transitory computer readable storage media include, but are not limited to, those manufactured from biological materials, nanowires, carbon nanotubes and individual molecules, even though the respective data storage technologies are currently under development and yet to be commercialized.

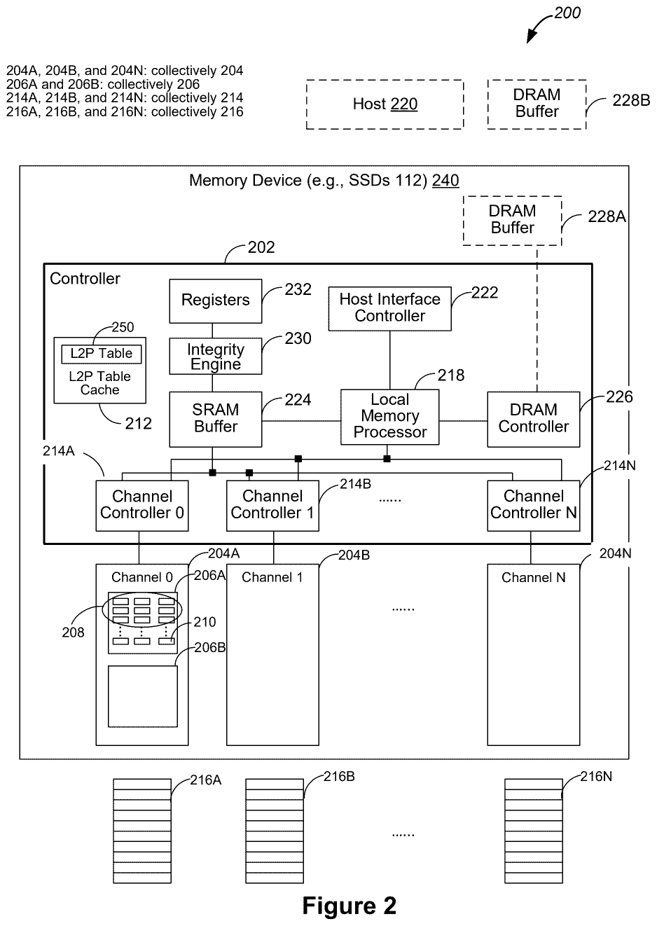

FIG. 2 is a block diagram of a memory system 200 of an example electronic device, in accordance with some embodiments. The memory system 200 is coupled to a host device 220 (e.g., a processor module 102 in FIG. 1) and configured to store instructions and data for an extended time, e.g., when the electronic device sleeps, hibernates, or is shut down. The host device 220 is configured to access the instructions and data stored in the memory system 200 and process the instructions and data to run an operating system (OS) and execute applications. The memory system 200 includes one or more memory devices 240 (e.g., SSD(s)). Each memory device 240 further includes a controller 202 and a plurality of memory channels 204 (e.g., channel 204A, 204B, and 204N). Each memory channel 204 includes a plurality of memory cells. The controller 202 is configured to execute firmware level software to bridge the plurality of memory channels 204 to the host device 220. In some embodiments, each memory device 240 is formed on a printed circuit board (PCB).

Each memory channel 204 includes one or more memory packages 206 (e.g., two memory dies). In an example, each memory package 206 (e.g., memory package 206A or 206B) corresponds to a memory die. Each memory package 206 includes a plurality of memory planes 208, and each memory plane 208 further includes a plurality of memory pages 210. Each memory page 210 includes an ordered set of memory cells, and each memory cell is identified by a respective physical address. In some embodiments, the memory device 240 includes a plurality of superblocks. Each superblock includes a plurality of memory blocks each of which further includes a plurality of memory pages 210. For each superblock, the plurality of memory blocks are configured to be written into and read from the memory system via a memory input/output (I/O) interface concurrently. Optionally, each superblock groups memory cells that are distributed on a plurality of memory planes 208, a plurality of memory channels 204, and a plurality of memory dies 206. In an example, each superblock includes at least one set of memory pages, where each page is distributed on a distinct one of the plurality of memory dies 206, has the same die, plane, block, and page designations, and is accessed via a distinct channel of the distinct memory die 206. In another example, each superblock includes at least one set of memory blocks, where each memory block is distributed on a distinct one of the plurality of memory dies 206 includes a plurality of pages, has the same die, plane, and block designations, and is accessed via a distinct channel of the distinct memory die 206. The memory device 240 stores information of an ordered list of superblocks in a cache of the memory device 240. In some embodiments, the cache is managed by a host driver of the host device 220, and called a host managed cache (HMC).

In some embodiments, the memory device 240 includes a single-level cell (SLC) NAND flash memory chip, and each memory cell stores a single data bit. In some embodiments, the memory device 240 includes a multi-level cell (MLC) NAND flash memory chip, and each memory cell of the MLC NAND flash memory chip stores 2 data bits. In an example, each memory cell of a triple-level cell (TLC) NAND flash memory chip stores 3 data bits. In another example, each memory cell of a quad-level cell (QLC) NAND flash memory chip stores 4 data bits. In yet another example, each memory cell of a penta-level cell (PLC) NAND flash memory chip stores 5 data bits. In some embodiments, each memory cell can store any suitable number of data bits (e.g., X data bits, where X is greater than 5). Compared with the non-SLC NAND flash memory chips (e.g., MLC SSD, TLC SSD, QLC SSD, PLC SSD), the SSD that has SLC NAND flash memory chips operates with a higher speed, a higher reliability, and a longer lifespan, and however, has a lower device density and a higher price.

Each memory channel 204 is coupled to a respective channel controller 214 (e.g., controller 214A, 214B, or 214N) configured to control internal and external requests to access memory cells in the respective memory channel 204. In some embodiments, each memory package 206 (e.g., each memory die) corresponds to a respective queue 216 (e.g., queue 216A, 216B, or 216N) of memory access requests. In some embodiments, each memory channel 204 corresponds to a respective queue 216 of memory access requests. Further, in some embodiments, each memory channel 204 corresponds to a distinct and different queue 216 of memory access requests. In some embodiments, a subset (less than all) of the plurality of memory channels 204 corresponds to a distinct queue 216 of memory access requests. In some embodiments, all of the plurality of memory channels 204 of the memory device 240 corresponds to a single queue 216 of memory access requests. Each memory access request is optionally received internally from the memory device 240 to manage the respective memory channel 204 or externally from the host device 220 to write or read data stored in the respective channel 204. Specifically, each memory access request includes one of: a system write request that is received from the memory device 240 to write to the respective memory channel 204, a system read request that is received from the memory device 240 to read from the respective memory channel 204, a host write request that originates from the host device 220 to write to the respective memory channel 204, and a host read request that is received from the host device 220 to read from the respective memory channel 204. It is noted that system read requests (also called background read requests or non-host read requests) and system write requests are dispatched by a memory controller 202 to implement internal memory management functions including, but are not limited to, garbage collection, wear levelling, read disturb mitigation, memory snapshot capturing, memory mirroring, caching, and memory sparing. In some embodiments, each of a host write request and a host read request corresponds to a respective input/output (I/O) access operation. Alternatively, in some embodiments, each of a system read request, a system write request, a host write request, and a host read request corresponds to a respective input/output (I/O) access operation

In some embodiments, in addition to the channel controllers 214, the controller 202 further includes a local memory processor 218, a host interface controller 222, an SRAM buffer 224, and a DRAM controller 226. The local memory processor 218 accesses the plurality of memory channels 204 based on the one or more queues 216 of memory access requests. In some embodiments, the local memory processor 218 writes into and read from the plurality of memory channels 204 on a memory block basis. Data of one or more memory blocks are written into, or read from, the plurality of channels jointly. No data in the same memory block is written concurrently via more than one operation. Each memory block optionally corresponds to one or more memory pages. In an example, each memory block to be written or read jointly in the plurality of memory channels 204 has a size of 16 KB (e.g., one memory page). In another example, each memory block to be written or read jointly in the plurality of memory channels 204 has a size of 64 KB (e.g., four memory pages). In some embodiments, each memory block has a size corresponding to a plurality of pages distinct from 16 KB and 64 KB. In some embodiments, each page has 16 KB user data and 2 KB metadata. Additionally, a number of memory blocks to be accessed jointly and a size of each memory block are configurable for each of the system read, host read, system write, and host write operations.

In some embodiments, the local memory processor 218 stores data to be written into, or read from, each memory block in the plurality of memory channels 204 in an SRAM buffer 224 of the controller 202. Alternatively, in some embodiments, the local memory processor 218 stores data to be written into, or read from, each memory block in the plurality of memory channels 204 in a DRAM buffer 228A that is included in memory device 240, e.g., by way of the DRAM controller 226. Alternatively, in some embodiments, the local memory processor 218 stores data to be written into, or read from, each memory block in the plurality of memory channels 204 in a DRAM buffer 228B that is main memory used by the processor module 102 (FIG. 1). The local memory processor 218 of the controller 202 accesses the DRAM buffer 228B via the host interface controller 222.

In some embodiments, data in the plurality of memory channels 204 is grouped into coding blocks, and each coding block is called a codeword. For example, each codeword includes n bits among which k bits correspond to user data and (n-k) corresponds to integrity data of the user data, where k and n are positive integers. In some embodiments, the memory device 240 includes an integrity engine 230 (e.g., an LDPC engine) and registers 232, which include a plurality of registers or SRAM cells or flip-flops and are coupled to the integrity engine 230. The integrity engine 230 is coupled to the memory channels 204 via the channel controllers 214 and SRAM buffer 224. Specifically, in some embodiments, the integrity engine 230 has data path connections to the SRAM buffer 224, which is further connected to the channel controllers 214 via data paths that are controlled by the local memory processor 218. The integrity engine 230 is configured to verify data integrity and correct bit errors for each coding block of the memory channels 204.

In some embodiments, the memory system 200 includes an SSD having an L2P address indirection table 250 that stores physical addresses for a set of logical addresses, e.g., a logical block address (LBA). In some embodiments, the L2P address indirection table 250 is stored in an L2P table cache 212 included in the controller 202. Alternatively, in some embodiments, the memory system 200 includes a DRAM buffer 228A, and the L2P address indirection table 250 is stored in the DRAM buffer 228A. The local memory processor 218 of the controller 202 accesses the DRAM buffer 228A via a DRAM controller 226.

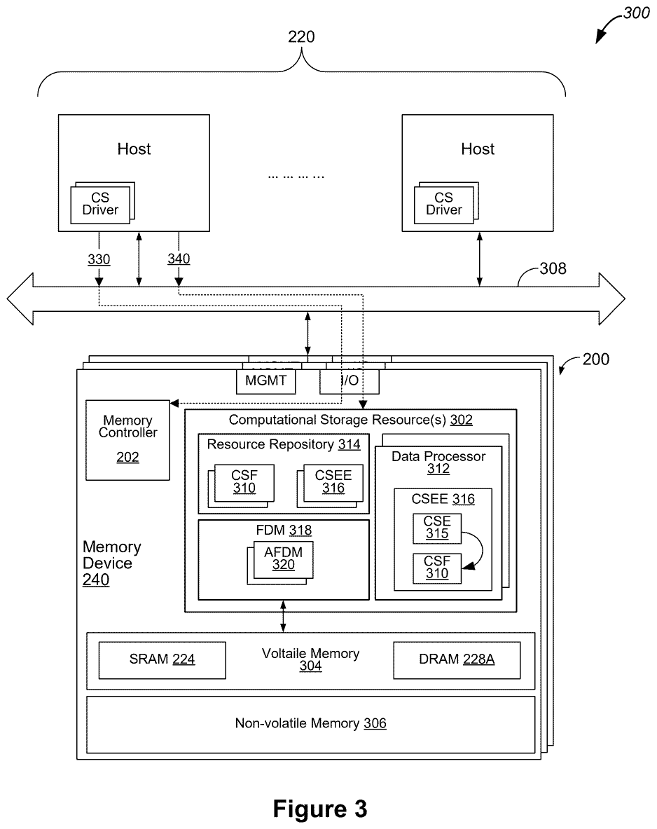

In some embodiments, a memory device 240 (also called a storage device) includes a plurality of processing cores, and is transformed to a CSD by activating a computational storage configuring two separate subsets of processing cores to a memory controller 202 and a data processor (e.g., data processor 312 in FIG. 3), respectively. The data processor is configured to process internal computational storage operations (e.g., data processing operations) locally on the memory device 240, while the memory controller 202 of the memory device 240 specializes in performing generic storage functions including memory access functions (e.g., input/output (I/O) access operations) and internal memory management functions. In some embodiments, the memory controller 202 and the data processor of the memory device 240 at least partially share certain hardware resources in a time-multiplexed manner. The memory device 240 may operate in a computational storage elevation (CSE) mode, when the hardware resources (e.g., processing cores) are allocated to the computational storage functions or adjusted between the memory access functions and the computational storage functions.

FIG. 3 is a block diagram of an example electronic system 300 that includes a memory system 200 having an internal processing capability, in accordance with some embodiments. The memory system 200 is also called a CSD, and includes one or more memory devices 240 (e.g., SSDs). Each memory device 240 further includes a memory controller 202, a volatile memory 304, and a non-volatile memory 306 (e.g., memory channels 204). The host device(s) 220 and the one or more memory devices 240 of the memory system 200 are coupled to each other via a communication fabric 308. The communication fabric 308 includes a communication bus 140 (FIG. 1) that operates in compliance with a data bus standard, e.g., Peripheral Component Interconnect Express (PCIe), Ethernet standards. The host device(s) 220 are configured to issue memory access requests to write data into, and read data from, the non-volatile memory 306. The memory controller 202 accesses the non-volatile memory 306 in response to the memory access operations. Additionally, in some embodiments, the memory controller 202 dispatch system read requests (also called background read requests or non-host read requests) and system write requests to implement internal memory management functions including, but are not limited to, garbage collection, wear levelling, read disturb mitigation, memory snapshot capturing, memory mirroring, caching, and memory sparing. The volatile memory 304 of each memory device 240 further includes one or more of a L2P table cache 212, an SRAM buffer 224, and a DRAM buffer 228A, and is configured to store data temporarily while the memory controller 202 accesses the non-volatile memory 306 for memory accesses or internal memory management.

In some embodiments, the memory controller 202 is dedicated to processing the memory access requests and internal memory management functions. A memory device 240 further includes one or more computational storage resources (CSRs) 302 configured to implement data processing operations locally on the memory device 240. A set of predefined data processing operations are implemented to perform a computational storage function (CSF) 310, which is distinct from the memory access and internal memory management functions performed by the memory controller 202. In some embodiments, a computational storage resource 302 processes user data that are received from the host device(s) 220 or extracted from the non-volatile memory 306 during the data processing operations. In some embodiments, the processed data are stored into the non-volatile memory 306 or sent to the host device(s) 220 via the fabric 308. Further, in some embodiments, a subset of the user data, the process data, and intermediate data generated during the data processing operations is temporarily stored in the volatile memory 304 (e.g., SRAM buffer 224, DRAM buffer 228A).

In some embodiments, the computational storage resource 302 includes one or more data processors 312 and a resource repository 314. The one or more data processors 312 provide a computational storage engine configured to perform one or more predefined data processing operations, e.g., associated with a computational storage function 310 of the computational storage resource 302. In some embodiments, the computational storage function 310 corresponds to an in-memory application associated with the computational storage engine, and is implemented via the computational storage engine in the memory device 240. The resource repository 314 is a centralized location (e.g., memory space) storing various types of data and resources, such as software libraries, configuration files, media files, or any other type of data needed for a plurality of computational storage functions 310 performed by the computational storage resource 302. For example, the resource repository 314 stores instructions for creating a computational storage engine environment (CSEE) 316 and instructions for implementing a set of data processing operations associated with a computational storage function 310 in the CSEE 316. Instructions are loaded from the resource repository 314 and executed by the data processor 312, thereby creating the CSEE 316 where the computational storage engine 315 is executed to implement data processing operations associated with the computational storage function 310.

In some embodiments, the computational storage resource 302 further includes a function data memory (FDM) 318 for storing data that are used or generated by the computational storage engine 315 for performing a computational storage function 310. In some embodiments, the function data memory 318 is included in the volatile memory 304. For example, the function data memory 318 corresponds to a portion of the DRAM buffer 228A (FIG. 2). In another example, the function data memory 318 corresponds to a portion of the SRAM buffer 224 (FIG. 2). Further, in some embodiments, a portion of the function data memory 318 (also called an allocated FDM (AFDM) 320) is allocated for one or more instances of a computational storage function 310.

In some embodiments, a host device 22 issues a memory read or write request 330 to a memory device 240 of the memory system 200, and the memory controller 202 of the memory device 240 receives the memory read or write request 330 and accesses the non-volatile memory 306 accordingly. Alternatively, in some embodiments, a host device 22 issues a data processing request 340 to the memory device 240, and a data processor 312 of the computational storage resource 302 (e.g., the computational storage engine 315) receives the data processing request 340 and processes user data extracted from the data processing request or the non-volatile memory 306.

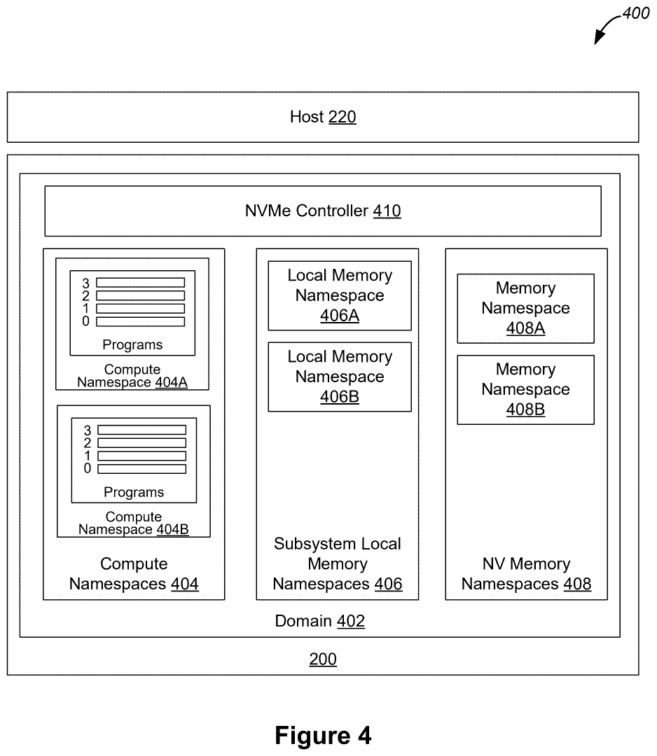

FIG. 4 is a block diagram of an example computer system 400 including a memory system 200 that operates in compliance with a storage access and transport protocol (e.g., nonvolatile memory express (NVMe)), in accordance with some embodiments. The memory system 200 includes one or more memory devices 240 each of which corresponds to a domain 402 according to the storage access and transport protocol. Each domain 402 corresponding to a respective memory device 240 includes a one or more compute namespace 404, local memory namespaces 406, memory namespaces 408, and a domain controller 410. Each namespace is a collection of LBAs accessible to, or associated with, a respective one of the plurality of programs.

A memory device 240 includes one or more processors having a computation capability (e.g., a memory controller 202, a data processor 312), a volatile memory 304 (e.g., a cache 212, an SRAM buffer 224, a DRAM buffer 228A), and a non-volatile memory 306. When the memory device 240 executes a plurality of programs, resources of the memory controller 202, the volatile memory 304, and the non-volatile memory 306 are allocated to implement the plurality of programs based on the storage access and transport protocol (e.g., NVMe). A plurality of compute namespaces 404 (e.g., 404A and 404B) correspond to, are configured to provide, instructions of the plurality of programs executed by the one or more programs of the memory device 240. Resources of the volatile memory 304 are allocated based on a plurality of local memory namespaces 406 (e.g., 406A and 406B) to facilitate execution of the plurality of programs by the memory device 240, so are resources of the non-volatile memory 306 allocated based on a plurality of memory namespaces 408 (e.g., 408A and 408B). It is noted that, in some embodiments, a number of programs is not limited to 2 and may be greater than 2, thereby creating more than two namespaces in each type of compute namespaces 404, 406, or 408.

In an example, a compute namespace 404A corresponds to a respective local memory namespace 406A and a respective non-volatile memory namespace 408A. The compute namespace 404A provides instructions of a corresponding program for execution by the one or more processors of the memory device 240. In some situations, input data that are processed, and output data that are generated, by these instructions are temporarily stored based on the local memory namespace 406A. In some situations, the input data are extracted based on the non-volatile memory namespace 408A, and the output data are stored based on the non-volatile memory namespace 408A. By these means, namespace allocation and utilization in the domain 402 corresponding to the memory device 240 are managed according to the storage access and transport protocol.

In some embodiments, the storage access and transport protocol includes an NVMe protocol for accessing flash storage (e.g., SSDs) via a PCI Express (PCIe) bus. The PCIe bus is configured to support a plurality of parallel command queues (e.g., on an order of 104 queues), thereby operating with a substantially high throughput and a substantially fast response time. In some embodiments, the host device 220 is configured to communicate and interact with each memory device 240 (e.g., SSD) as a standard NVMe memory device using the NVMe protocol. The host device 220 is configured to read and write data and implement data processing operations on the memory device 240 using NVMe commands.

In some embodiments, the host device 220 uses an operating system (e.g., a Linux operating system), and the CSRs 302 (FIG. 3) of the memory device 240 uses an embedded operating system (e.g., an embedded Linux operating system) that matches the operating system of the host device 220. In some embodiments, the host device 220 uses extended vendor unique commands to control and interact with the embedded operating system of the CSRs 302 of the memory device 240.

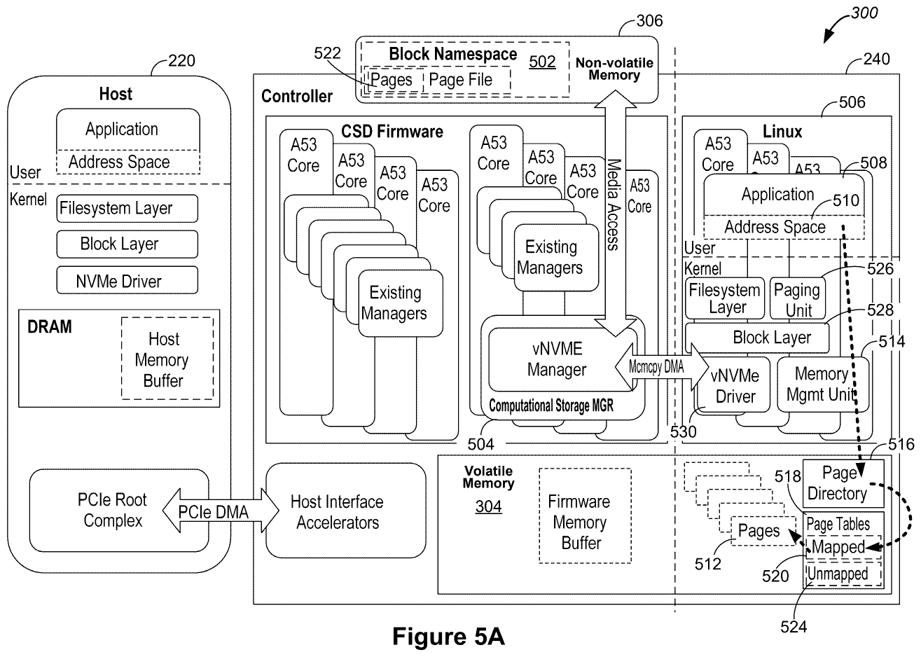

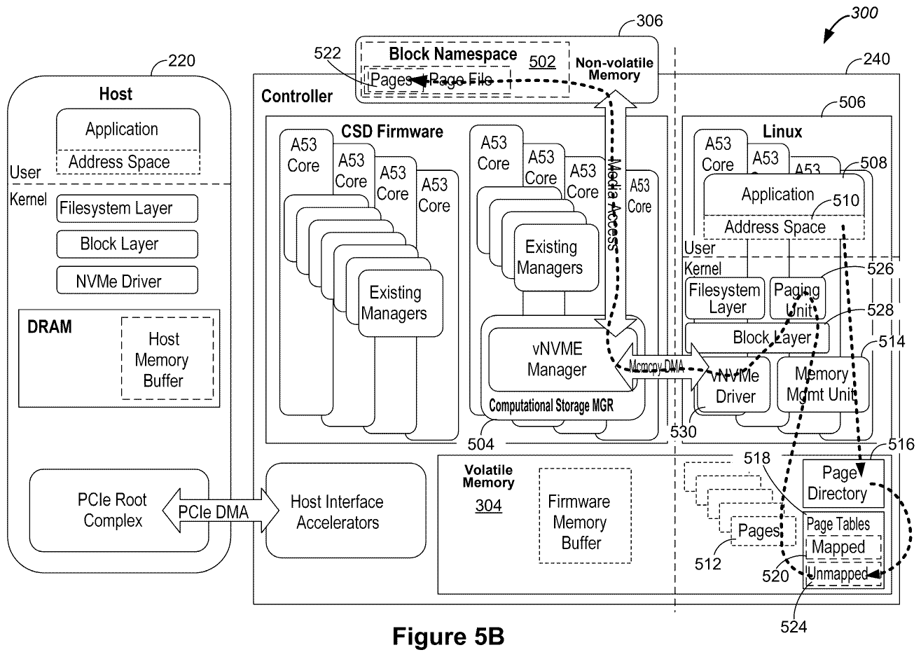

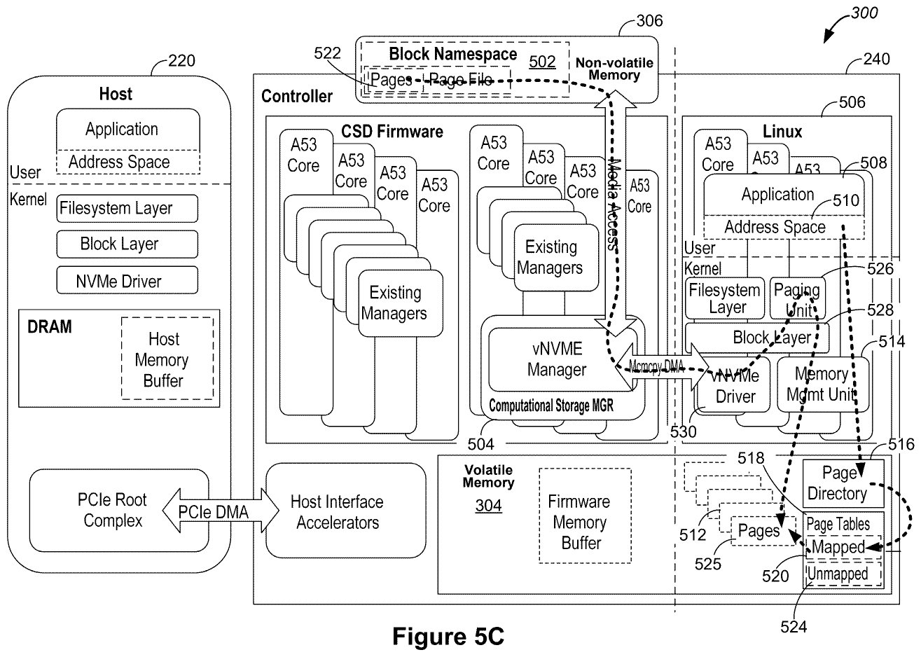

FIGS. 5A-5C are block diagrams of an example electronic system 300 that uses a block namespace 502 for storing and retrieving data (e.g., a file) based on memory pages 210, in accordance with some embodiments. The electronic system 300 includes a memory device 240 (e.g., an SSD) coupled to a host 220. The memory device 240 further includes a storage manager 504 and a Linux compute system 506. Some implementations of this application are directed to a shared memory architecture in which volatile memory 304 (e.g., DRAM 228A, SRAM 224) is shared between memory storage functions and compute functions of the memory device 240 dynamically, e.g., using established NVMe protocol semantics. The block namespace 502 may be isolated and used for paging a file for the Linux compute system 506, thereby providing an accelerated pathway due to the shared memory architecture. For example, data may be moved into and out of a shared L3 cache using memcpy, which is a standard C library function used to copy a block of memory from one location to another. In some embodiments, the memory device 240 operates in a single level cell (SLC) mode, when the shared memory architecture is applied.

In some embodiments, the Linux compute system 506 executes an application 508 having an address space 510 on an application level. The address space 510 includes a plurality of address space mappings to associate virtual addresses of the application 508 to physical addresses of pages 512 stored in the volatile memory 304 (e.g., the DRAM buffer 228A). A memory management unit (MMU) 514 is applied in an operating system kernel to configure the address space mappings of the address space 510 associated with the page 512 stored in the DRAM buffer 228A. In some embodiments, referring to FIG. 5A, the MMU 514 identifies a physical page 512 stored in the volatile memory 304 (e.g., the DRAM buffer 228A) in response to a request for an application page of the application 508 corresponding to a logical address. More specifically, the MMU 514 checks a page directory 516 to identify a page table 518 to identify the physical page 512 among a mapped portion 520 storing physical addresses of locally mapped pages (e.g., including a physical address of the page 512 within the DRAM buffer 228A).

In some embodiments, page table entries are mapped, indicating there is a page 512 backing every application page of the application 508. Conversely, in some embodiments, a translation lookaside buffer (TLB) miss happens when no physical page 512 stored in the DRAM buffer 228A is found for a logical address of the application 508. TLB miss causes a page table walk to identify a page 522 stored in the non-volatile memory 306 based on logical-to-physical (L2P) mapping. Referring to FIG. 5B, in some embodiments, the application 508 issues a request for a page 522, causing a page fault. A TLB miss happens. Information of the page 522 is stored in an unmapped portion 524 of the page tables 518. Transaction is routed through a kernel paging subsystem to extract the information of the page 522 from the unmapped portion 524 and identify the page 522 in a page file in the block namespace 502 on the non-volatile memory 306 based on the extracted information of the page 522. In some embodiments, the page directory 516 and the page table 518 are stored in a TLB. The TLB may be stored an SRAM buffer 224 or the DRAM buffer 228A.

Referring to FIG. 5C, in some embodiments, the page 522 is copied from the non-volatile memory 306 into a victim cache location (e.g., as a page 525) in the DRAM buffer 228A and mapped into the address space 510 associated with the application 508. A page fault handler returns, e.g., to store information of the page 525 (e.g., a physical address of the victim cache location) in the mapped portion 524 in the page tables 518. The application 508 can freely access the pages (e.g., page 512 or 525) identified in the mapped portion 524. In some embodiments, the kernel paging subsystem includes one or more of the MMU 514, a paging unit 526, a block layer 528, and a driver 530. The kernel paging subsystem is implemented by a data processor 312 of the memory device 240, and collaborates with the storage manager 504 implemented by a memory controller 202.

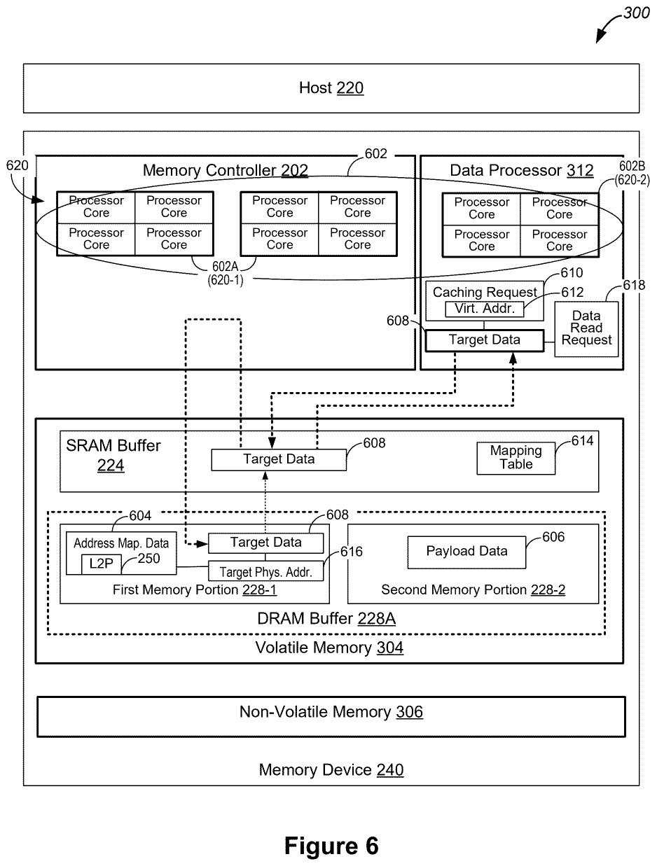

FIG. 6 is a block diagram of an example electronic system 300 that shares volatile memory space to facilitate in-memory data processing in a memory device 240, in accordance with some embodiments. The electronic system 300 includes a memory device 240 (e.g., an SSD) coupled to a host 220. The memory device 240 includes a plurality of processor cores 602, a volatile memory 304, and a non-volatile memory 306. The volatile memory 304 of each memory device 240 further includes an SRAM buffer 224 and a DRAM buffer 228A, and is configured to store data temporarily. The non-volatile memory 306 (e.g., an SSD) includes a plurality of memory channels 204 configured to store data independently of whether the electronic system 300 is decoupled from a power source.

The electronic system 300 allocates a first subset of processor cores 602A to perform a plurality of memory access and management functions of a memory controller 202, and a second subset of processor cores 602B to perform a plurality of in-memory data processing functions of as a data processor 312. In some embodiments, an embedded operating system (e.g., Linux OS) is executed in the data processor 312 to perform the plurality of in-memory data processing functions. The volatile memory 304 is partitioned to a first memory portion 228-1 for storing address mapping data 604 temporarily for the memory controller 202 and a second memory portion 228-2 for storing payload data 606 (e.g., pages 512 and 525 in FIGS. 5A-5C) temporarily for the data processor 312. In some embodiments, the volatile memory 304 includes an SRAM buffer 224 and a DRAM buffer 228A (FIG. 2), and the DRAM buffer 228A is partitioned to the first memory portion 228-1 and the second memory portion 228-2.

In some embodiments, the data processor 312 issues a caching request 610 for storing target data 608 (e.g., page 512) temporarily in the volatile memory 304. the data processor 312 determines that the second memory portion 228-2 associated with the data processor 312 has insufficient memory space to store the target data 608. In response to the caching request 610, in accordance with a determination that the second memory portion 228-2 has insufficient memory space, the electronic system 300 stores the target data 608 in the first memory portion 228-1 via the memory controller 202. In some embodiments, the target data 608 have a predefined data size granularity, e.g., is measured in a size of a memory page 210. Examples of a size of a memory page 210 is 4 KB, 16 KB, and 64 KB. A minimum size of the target data 608 is the size of the memory page 210.

In some embodiments, the caching request 610 further includes a virtual address 612 of the target data. After the target data 608 are stored in the first memory portion 228-1, the data processor 312 updates a mapping table 614 associating the virtual address 612 of the target data 608 with a target physical address 616 within the first memory portion 228-1 of the volatile memory 304. The mapping table 614 includes a page directory 516 and a plurality of page tables 518 (FIGS. 5A-5C). In some situations, the mapping table 614 is stored in the SRAM buffer 224. In some situations, the mapping table 614 is stored in a dedicated mapping cache (not shown). Alternatively, in some situations, the mapping table 614 is stored in the second memory portion 228-2 allocated to the data processor 312 within the DRAM buffer 228A. In other words, in some embodiments, the mapping table 614 is stored in one of the SRAM and the second memory portion 228-2 of the DRAM buffer 228A.

Further, in some embodiments, the data processor 312 generates a data read request 618 for extracting the target data 608, and the data read request 618 includes the virtual address 612 of the target data 608. In response to the data read request 618, the data processor 312 determines that the target data 608 is stored in the first memory portion 228-1 based on the mapping table 614 and extracts the target data 608 from the first memory portion 228-1 based on the target physical address 616. In some embodiments, given the known target physical address 616, the data processor 312 extracts the target data 608 from the non-volatile memory 306 without involving the memory controller 202.

In some embodiments, the plurality of processor cores 602 are grouped into a plurality of clusters 620. The first subset of processor cores 602A of the memory controller 202 correspond to a first set of one or more clusters 620-1, and the second subset of processor cores 602B of the data processor 312 correspond to a second set of one or more clusters 620-2. In an example, the memory device 240 includes 12 processor cores 602 grouped into 3 clusters 620. Two clusters 620-1 are allocated to form the memory controller 202, performing the plurality of memory access and management functions. A remainder cluster 620-2 is allocated to form the data processor 312, performing the plurality of in-memory data processing functions. The mapping table 614 is stored in a cluster-level L3 cache associated with the data processor 312. The L3 cache may be implemented in the SRAM buffer 224, and shared by the first set of clusters 620-1 and the second set of one or more clusters 620-2.

Further, in some embodiments, the electronic system 300 stores the target data 608 in the first memory portion 228-1 via the memory controller 202. More specifically, the data processor 312 stores the target data 608 in the cluster-level L3 cache (e.g., the SRAM buffer 224). The memory controller 202 extracts the target data from the cluster-level L3 cache and stores the target data 608 in the first memory portion 228-1.

In some embodiments, when the electronic system 300 stores the target data 608 in the first memory portion 228-1, a data storage request including the target data is extended from the data processor 312 to the memory controller 202. In response to the data storage request, the memory controller 202 stores the target data 608 in the first memory portion 228-1. After the target data 608 are stored, the data processor 312 receives a message indicating that the target data 608 is stored in the target physical address 616 in the first memory portion 228-1. In some embodiments, the target data 608 are further stored in the non-volatile memory 306 by the memory controller 202.

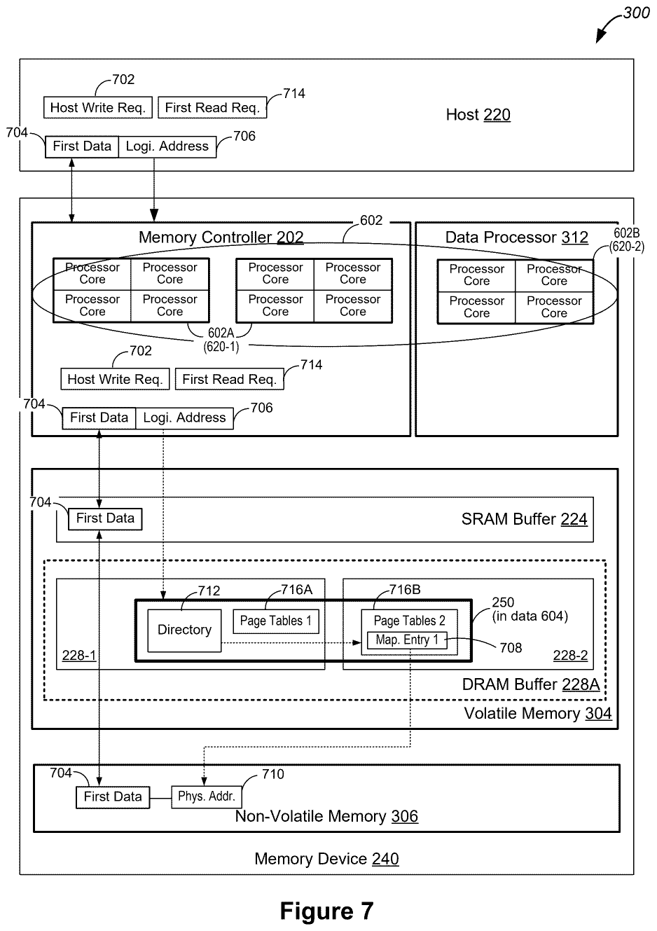

FIG. 7 is a block diagram of an example electronic system 300 that shares volatile memory space to facilitate storage functions of a memory device 240, in accordance with some embodiments. The electronic system 300 includes a memory device 240 (e.g., an SSD) coupled to a host 220. The memory device 240 includes a plurality of processor cores 602, a volatile memory 304, and a non-volatile memory 306. The electronic system 300 allocates a first subset of processor cores 602A to perform a plurality of memory access and management functions of a memory controller 202, and a second subset of processor cores 602B to perform a plurality of in-memory data processing functions of as a data processor 312. The volatile memory 304 is partitioned to a first memory portion 228-1 for storing address mapping data 604 temporarily for the memory controller 202 and a second memory portion 228-2 for storing payload data 606 temporarily for the data processor 312. In some embodiments, the volatile memory 304 includes an SRAM buffer 224 and a DRAM buffer 228A (FIG. 2), and the DRAM buffer 228A is partitioned to the first memory portion 228-1 and the second memory portion 228-2.

In some embodiments, the memory device 240 is coupled to a host device 220. The memory controller 202 receives a host write request 702 including first data 704 and a logical address 706 of the first data 704. The memory controller 202 determines that the first memory portion 228-1 has insufficient memory space to store a first mapping entry 708 translating the logical address 706 of the first data 704 to a physical address 710 of the first data 704. In response to the host write request 702, in accordance with a determination that the first memory portion 228-1 has insufficient memory space, the memory controller 202 determines a physical address 710 of the first data 704 stored in the non-volatile memory 306 for storing the first data 704, and stores the first mapping entry 708 (e.g., including the physical address 710 of the first data 704) in the second memory portion 228-2. The first data 704 are stored in the non-volatile memory 306 based on the physical address 710 of the first data 704.

Further, in some embodiments, the address mapping data 604 include an L2P table 250 further having a directory 712. In response to the host write request 702, in accordance with a determination that the first memory portion 228-1 has insufficient memory space to store the first mapping entry 708, the memory controller 202 updates the directory 712 of the L2P table 250 stored in the first memory portion 228-1 to point to the first mapping entry 708 stored in the second memory portion 228-2.

In some embodiments, the memory controller 202 receives a first read request 714 for the first data 704, and the first read request 714 includes the logical address 706 of the first data 704. In response to the first read request 714, the memory controller 202 determines that the physical address of the first data 704 is stored in the second memory portion 228-2 associated with the data processor 312. The memory controller 202 obtains the physical address 710 of the first data 704 from the second memory portion 228-2, and extracts the first data 704 from the non-volatile memory 306 based on the physical address 710 of the first data 704.

In some embodiments, the volatile memory 304 includes an SRAM buffer 224 and a DRAM buffer 228A (FIG. 2), and the DRAM buffer 228A is partitioned to the first memory portion 228-1 and the second memory portion 228-2. The first data 704 are temporarily stored in the SRAM buffer 224 before the first data 704 are stored in the non-volatile memory 306 based on the physical address 710 of the first data 704.

Referring to FIG. 7, in some embodiments, the L2P table 250 applied by the memory controller 202 includes a directory 712 and a plurality of page tables 716A and 716B. Each page table 716A or 716B includes a plurality of mapping entries mapping logical addresses of a host application to physical addresses in the non-volatile memory 306. The plurality of mapping entries include the first mapping entry 708 translating the logical address 706 of the first data 704 to the physical address 710 of the first data 704. The plurality of page tables includes a first set of page tables 716A and a second set of page tables 716B. The first memory portion 228-1 allocated to the memory controller 202 stores the directory 712 and the first set of page tables 716A, and the second set of page tables 716B including the first mapping entry 708 is stored in the second memory portion 228-2, which is allocated to implement the data processing functions of the data processor 312 of the memory device 240.

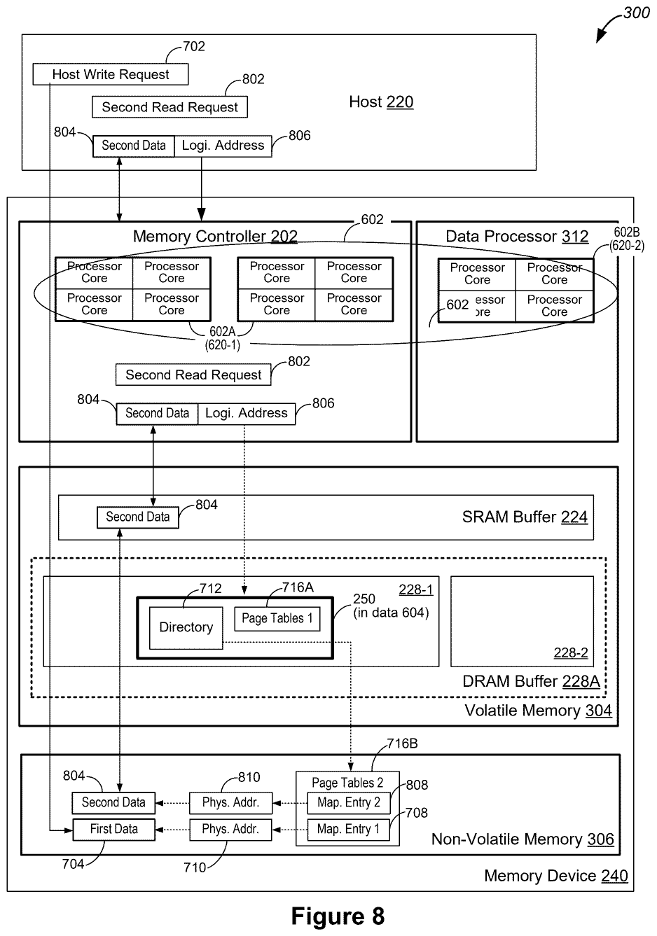

FIG. 8 is a block diagram of an example electronic system 300 that stores one or more page tables 716B in a non-volatile memory 306 in a memory device 240, in accordance with some embodiments. In some embodiments, the memory device 240 is coupled to a host device 220. The memory controller 202 receives a host write request 702 including first data 704 and an associated logical address 706 of the first data 704. The memory controller 202 determines that the first memory portion 228-1 has insufficient memory space to store a first mapping entry 708 translating the logical address 706 of the first data 704 to a physical address 710 of the first data 704. In response to the host write request 702, the memory controller 202 determines a physical address 710 in the non-volatile memory 306 for storing the first data 704, and stores the first mapping entry 708 in the non-volatile memory 306 directly. The first data 704 are stored in the non-volatile memory 306 based on the physical address 710 of the first data 704. Further, in some embodiments, the address mapping data 604 include an L2P table 250 further having a directory 712. In response to the host write request 702, the memory controller 202 updates the directory 712 of the L2P table 250 stored in the first memory portion 228-1 to point to the first mapping entry 708 stored in the non-volatile memory 306.

In some embodiments, the address mapping data 604 include an L2P table 250. The memory controller 202 receives a second read request 802 for second data 804, and the second read request 802 includes a logical address 806 of the second data 804. In response to the second read request 802, the memory controller 202 searches the L2P table 250 based on the logical address 806 of the second data 804 to identify a second mapping entry 808. The second mapping entry 808 translates the logical address 806 of the second data 804 to a physical address 810 of the second data 804 in the non-volatile memory 306. The memory controller 202 extracts the second data 804 from the non-volatile memory 306 based on the physical address 810 of the second data 804.

Referring to FIG. 8, in some embodiments, the L2P table 250 applied by the memory controller includes a directory 712 and a plurality of page tables 716. The plurality of page tables 716 includes a first set of page tables 716A and a second set of page tables 716B. The first memory portion 228-1 allocated to the memory controller 202 stores the directory 712 and the first set of page tables 716A, and the second set of page tables 716B including the first mapping entry 708 is stored in the non-volatile memory 306.

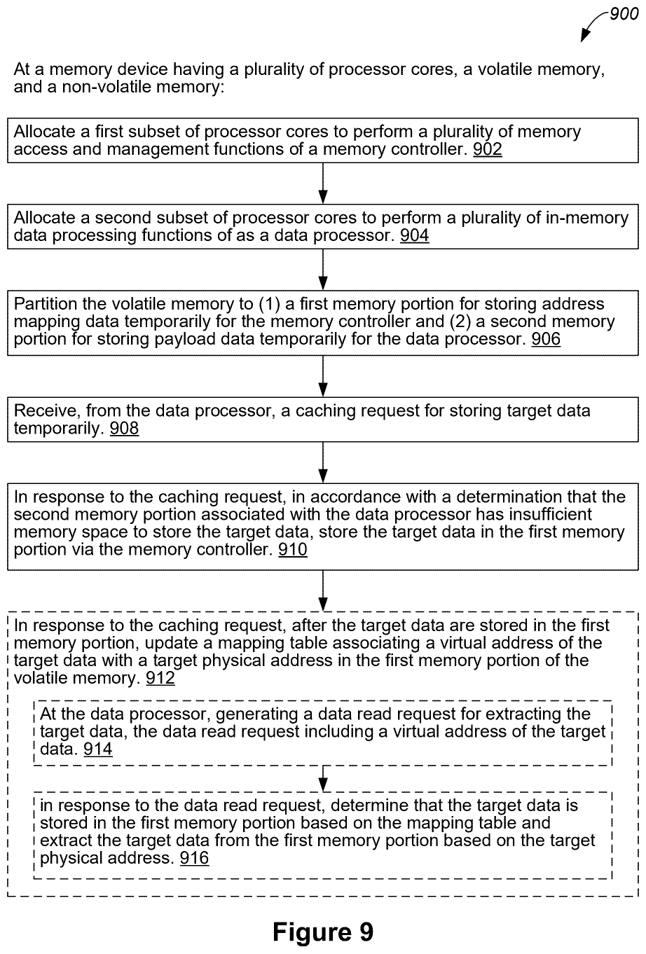

FIG. 9 is a flow diagram of an example method 900 for managing volatile memory space in a memory device 240 (e.g., a CSD), in accordance with some embodiments. The method 900 is implemented by a memory device 240 having a plurality of processor cores 602, a volatile memory 304, and a non-volatile memory 306. The memory device 240 240 allocates (operation 902) a first subset of processor cores 602A to perform a plurality of memory access and management functions of a memory controller 202, and allocates (operation 904) a second subset of processor cores 602B to perform a plurality of in-memory data processing functions of as a data processor 312. The volatile memory 304 is partitioned (operation 906) to a first memory portion 228-1 for storing address mapping data 604 temporarily for the memory controller 202 and a second memory portion 228-2 for storing payload data temporarily for the data processor 312. A caching request 610 is received (operation 908) from the data processor 312 for storing target data 608 temporarily. In response to the caching request 610, in accordance with a determination that the second memory portion 228-2 associated with the data processor 312 has insufficient memory space to store the target data 608, the data processor 312 stores (operation 910) the target data 608 in the first memory portion 228-1 via the memory controller 202.

In some embodiments, in response to the caching request 610, after the target data 608 are stored in the first memory portion 228-1, the memory device 240 240 updates (operation 912) a mapping table 614 associating a virtual address 612 (VA) of the target data 608 with a target physical address 616 in the first memory portion 228-1 of the volatile memory 304. Further, in some embodiments, the data processor 312 generates (operation 914) a data read request 618 for extracting the target data 608, and the data read request 618 includes a virtual address 612 (VA) of the target data 608. In response to the data read request 618, the data processor 312 determines (operation 916) that the target data 608 is stored in the first memory portion 228-1 based on the mapping table 614 and extracts the target data 608 from the first memory portion 228-1 based on the target physical address 616 of the target data 608, e.g., without involving the memory controller 202.

In some embodiments, the plurality of processor cores are grouped into a plurality of clusters. The first subset of processor cores 602A of the memory controller 202 correspond to a first set of one or more clusters, and the second subset of processor cores 602B of the data processor 312 correspond to a second set of one or more clusters. The memory controller 202 and the data processor 312 share a cluster-level L3 cache.

In some embodiments, the memory device 240 is coupled to a host device. The memory controller 202 receives a host write request including first data 704 and a logical address 706 of the first data 704, and determines that the first memory portion 228-1 has insufficient memory space to store a first mapping entry translating the logical address 706 of the first data 704 to a physical address 710 of the first data 704. In response to the host write request, in accordance with a determination that the first memory portion 228-1 has insufficient memory space to store the first mapping entry, the memory device 240 determines the physical address 710 in the non-volatile memory 306 for storing the first data 704, stores the first mapping entry in one of the second memory portion 228-2 (FIG. 7) and the non-volatile memory 306 (FIG. 8), and stores the first data 704 in the non-volatile memory 306 based on the physical address 710 of the first data 704.

Further, in some embodiments, the memory device 240 (e.g., the memory controller 202) receives a first read request 702 for the first data 704, and the first read request 702 includes the logical address 706 of the first data 704. In response to the first read request 702, the memory controller 202 determines that the physical address 710 of the first data 704 is stored in the second memory portion 228-2 associated with the data processor 312, obtains the physical address 710 of the first data 704 from the second memory portion 228-2, and extracts the first data 704 from the non-volatile memory 306 based on the physical address 710 of the first data 704.

In some embodiments, the address mapping data 604 include an L2P table 250. The memory controller 202 receives a second read request 802 for second data 804, the second read request 802 including a logical address 806 of the second data 804. In response to the second read request 802, the memory controller 202 searches the L2P table 250 based on the logical address 806 of the second data 804 to determine a physical address 810 of the second data 804, and extracts the second data 804 from the non-volatile memory 306 based on the physical address 810 of the second data 804.

Stated another way, in accordance with some embodiments of this application is at least a realization that there is a need to share buffer space between a memory controller and a data processor of a memory device using storage semantics. In some embodiments, an address space may be statically allocated to either of the memory controller and the data processor at a boot time, and onboard buffer space (e.g., DRAM, SRAM) of the CSD is dynamically shared by the generic memory functions of the memory controller and the data processing operations of the data processor. More specifically, in some embodiments, DRAM, SRAM, or both are shared by a host-interfacing NVMe firmware and an in-memory Linux compute environment in a memory device (e.g., an SSD). The address space is statically allocated to each side at the boot time. The NVMe firmware has a flash translation layer (FTL) table having a limited size, and is associated with addressable memory units on a firmware side. The Linux compute environment managed by the data processor has certain amount of DRAM space available for data staging and manipulation on a compute side. Under some circumstances, at any one point in time, either side may not fully utilize or require its static allocation of memory, offering a possibility of lending its unused buffer space to the other side.

Some implementations of this application are directed to sharing memory (e.g., DRAM and SRAM) between memory storage and compute functions dynamically, e.g., using established NVMe protocol semantics to share memory from a host. In some embodiments, an isolated NAND namespace used for Linux paging file, and a pathway is accelerated due to a shared memory architecture. Data may be moved into and out of a shared L3 cache using memcpy. In some embodiments, a memory device operates in a single level cell (SLC) mode, when the shared memory architecture is applied.

Memory is also used to store instructions and data associated with the method 900, and includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory, optionally, includes one or more storage devices remotely located from one or more processing units. Memory, or alternatively the non-volatile memory within memory, includes a non-transitory computer readable storage medium. In some embodiments, memory, or the non-transitory computer readable storage medium of memory, stores the programs, modules, and data structures, or a subset or superset for implementing method 900.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

Various examples of aspects of the disclosure are described as numbered clauses (1, 2, 3, etc.) for convenience. These are provided as examples, and do not limit the subject technology. Identifications of the figures and reference numbers are provided below merely as examples and for illustrative purposes, and the clauses are not limited by those identifications.

Clause 1. A method for managing memory resources, comprising: at a memory device having a plurality of processor cores, a volatile memory, and a non-volatile memory: allocating a first subset of processor cores to perform a plurality of memory access and management functions of a memory controller; allocating a second subset of processor cores to perform a plurality of in-memory data processing functions of as a data processor; partitioning the volatile memory to (1) a first memory portion for storing address mapping data temporarily for the memory controller and (2) a second memory portion for storing payload data temporarily for the data processor; receiving, from the data processor, a caching request for storing target data temporarily; and in response to the caching request, in accordance with a determination that the second memory portion associated with the data processor has insufficient memory space to store the target data, storing the target data in the first memory portion via the memory controller.

Clause 2. The method of clause 1, further comprising: in response to the caching request, after the target data are stored in the first memory portion, updating a mapping table associating a virtual address of the target data with a target physical address in the first memory portion of the volatile memory.

Clause 3. The method of clause 2, further comprising, at the data processor: generating a data read request for extracting the target data, the data read request including a virtual address of the target data; and in response to the data read request, determining that the target data is stored in the first memory portion based on the mapping table and extracting the target data from the first memory portion based on the target physical address.

Clause 4. The method of clause 2 or 3, wherein the volatile memory includes a static random-access memory (SRAM) and a dynamic random-access memory (DRAM), and the DRAM is partitioned to the first memory portion and the second memory portion, wherein the mapping table is stored in one of the SRAM and the second memory portion of the DRAM.

Clause 5. The method of any of clauses 2-4, wherein: the plurality of processor cores are grouped into a plurality of clusters; the first subset of processor cores of the memory controller correspond to a first set of one or more clusters, and the second subset of processor cores of the data processor correspond to a second set of one or more clusters; and the mapping table is stored in a cluster-level L3 cache associated with the data processor.

Clause 6. The method of any of clauses 1-5, wherein: the plurality of processor cores are grouped into a plurality of clusters; the first subset of processor cores of the memory controller correspond to a first set of one or more clusters, and the second subset of processor cores of the data processor correspond to a second set of one or more clusters; and the memory controller and the data processor share a cluster-level L3 cache.

Clause 7. The method of clause 6, wherein storing the target data in the first memory portion via the memory controller further comprising: storing the target data in the cluster-level L3 cache by the data processor; extracting the target data from the cluster-level L3 cache by the memory controller; and storing the target data in the first memory portion by the memory controller.

Clause 8. The method of any of clauses 1-7, wherein storing the target data in the first memory portion via the memory controller further comprising: extending a data storage request including the target data from the data processor to the memory controller; storing the target data in the first memory portion via the memory controller; receiving, by the data processor, a message indicating that the target data is stored in a target physical address in the first memory portion.

Clause 9. The method of any of clauses 1-8, wherein the target data have a predefined data size granularity.

Clause 10. The method of any of clauses 1-9, wherein the memory device is coupled to a host device, the method further comprising, by the memory controller: receiving a host write request including first data and a logical address of the first data; determining that the first memory portion has insufficient memory space to store a first mapping entry translating the logical address of the first data to a physical address of the first data; and in response to the host write request, in accordance with a determination that the first memory portion has insufficient memory space to store the first mapping entry: determining a physical address of the first data in the non-volatile memory for storing the first data; storing the first mapping entry in one of the second memory portion and the non-volatile memory; and storing the first data in the non-volatile memory based on the physical address of the first data.

Clause 11. The method of clause 10, wherein the address mapping data include a logical-to-physical (L2P) table further having a directory, the method further comprising: in response to the host write request, in accordance with a determination that the first memory portion has insufficient memory space to store the first mapping entry, updating the directory of the L2P table stored in the first memory portion to point to the first mapping entry stored in the one of the second memory portion and the non-volatile memory.

Clause 12. The method of clause 10 or 11, further comprising, by the memory controller: receiving a first read request for the first data, the first read request including the logical address of the first data; and in response to the first read request: determining that the physical address of the first data is stored in the second memory portion associated with the data processor; obtaining the physical address of the first data from the second memory portion; and extracting the first data from the non-volatile memory based on the physical address of the first data.

Clause 13. The method of any of clause 10-12, further comprising the volatile memory includes an SRAM and a DRAM, which is partitioned to the first memory portion and the second memory portion, the method further comprising: temporarily storing the first data in the SRAM before the first data are stored in the non-volatile memory based on the physical address of the first data.

Clause 14. The method of any of clauses 1-13, wherein the address mapping data include an L2P table, the method further comprising, by the memory controller: receiving a second read request for second data, the second read request including a logical address of the second data; and in response to the second read request: searching the L2P table based on the logical address of the second data to determine a physical address of the second data; and extracting the second data from the non-volatile memory based on the physical address of the second data.

Clause 15. The method of clause 14, wherein the L2P table of the memory controller includes a directory, a first set of physical block addresses, and a second set of physical block addresses, and wherein the directory and the first set of physical block addresses are stored in the first memory portion, and the second of physical block addresses is stored in at least one of the second memory portion and the non-volatile memory.

Clause 16. The method of any of clauses 1-15, further comprising: executing an embedded operating system in the data processor, including performing the plurality of in-memory data processing functions.

Clause 17. A memory device, comprising having a plurality of processor cores, a volatile memory, and a non-volatile memory, wherein the memory device stores one or more programs comprising instructions for performing a method in any of clauses 1-16.

Clause 18. A non-transitory computer readable storage medium storing one or more programs, the one or more programs comprising instructions that, when executed by a memory device that includes a plurality of processor cores, a volatile memory, and a non-volatile memory, cause the memory device to perform a method in any of clauses 1-16.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

Each of the above identified elements may be stored in one or more of the previously mentioned storage devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

1. A method for managing memory resources, comprising:
at a memory device having a plurality of processor cores, a volatile memory, and a non-volatile memory:
allocating a first subset of processor cores to perform a plurality of memory access and management functions of a memory controller;
allocating a second subset of processor cores of the memory device to perform a plurality of in-memory data processing functions as a data processor, wherein the plurality of in-memory data processing functions are configured to process, locally on the memory device, data extracted from, or to be stored in, the non-volatile memory;
partitioning the volatile memory to (1) a first memory portion for storing address mapping data temporarily for the memory controller and (2) a second memory portion for storing payload data temporarily for the data processor;
storing the address mapping data used by the memory controller and the payload data used by the data processor separately in the first memory portion and the second memory portion of the volatile memory;
receiving, from the data processor, a caching request for storing target data temporarily; and
in response to the caching request, in accordance with a determination that the second memory portion associated with the data processor has insufficient memory space to store the target data, storing the target data in the first memory portion via the memory controller.

2. The method of claim 1, further comprising:
in response to the caching request, after the target data are stored in the first memory portion, updating a mapping table associating a virtual address of the target data with a target physical address in the first memory portion of the volatile memory.

3. The method of claim 2, further comprising, at the data processor:
generating a data read request for extracting the target data, the data read request including a virtual address of the target data; and
in response to the data read request, determining that the target data is stored in the first memory portion based on the mapping table and extracting the target data from the first memory portion based on the target physical address.

4. The method of claim 2, wherein the volatile memory includes a static random-access memory (SRAM) and a dynamic random-access memory (DRAM), and the DRAM is partitioned to the first memory portion and the second memory portion, wherein the mapping table is stored in one of the SRAM and the second memory portion of the DRAM.

5. The method of claim 2, wherein:
the plurality of processor cores are grouped into a plurality of clusters;
the first subset of processor cores of the memory controller correspond to a first set of one or more clusters, and the second subset of processor cores of the data processor correspond to a second set of one or more clusters; and
the mapping table is stored in a cluster-level L3 cache associated with the data processor.

6. The method of claim 1, wherein:
the plurality of processor cores are grouped into a plurality of clusters;
the first subset of processor cores of the memory controller correspond to a first set of one or more clusters, and the second subset of processor cores of the data processor correspond to a second set of one or more clusters; and
the memory controller and the data processor share a cluster-level L3 cache.

7. The method of claim 6, wherein storing the target data in the first memory portion via the memory controller further comprising:
storing the target data in the cluster-level L3 cache by the data processor;
extracting the target data from the cluster-level L3 cache by the memory controller; and
storing the target data in the first memory portion by the memory controller.

8. The method of claim 1, wherein storing the target data in the first memory portion via the memory controller further comprising:
extending a data storage request including the target data from the data processor to the memory controller;
storing the target data in the first memory portion via the memory controller;
receiving, by the data processor, a message indicating that the target data is stored in a target physical address in the first memory portion.

9. The method of claim 1, wherein the target data have a predefined data size granularity.

10. The method of claim 1, wherein the memory device is coupled to a host device, the method further comprising, by the memory controller:
receiving a host write request including first data and a logical address of the first data;
determining that the first memory portion has insufficient memory space to store a first mapping entry translating the logical address of the first data to a physical address of the first data; and
in response to the host write request, in accordance with a determination that the first memory portion has insufficient memory space to store the first mapping entry:
determining a physical address of the first data in the non-volatile memory for storing the first data;
storing the first mapping entry in one of the second memory portion and the non-volatile memory; and
storing the first data in the non-volatile memory based on the physical address of the first data.

11. The method of claim 10, wherein the address mapping data include a logical-to-physical (L2P) table further having a directory, the method further comprising:
in response to the host write request, in accordance with a determination that the first memory portion has insufficient memory space to store the first mapping entry, updating the directory of the L2P table stored in the first memory portion to point to the first mapping entry stored in the one of the second memory portion and the non-volatile memory.

12. The method of claim 10, further comprising, by the memory controller:
receiving a first read request for the first data, the first read request including the logical address of the first data; and
in response to the first read request:
determining that the physical address of the first data is stored in the second memory portion associated with the data processor;
obtaining the physical address of the first data from the second memory portion; and
extracting the first data from the non-volatile memory based on the physical address of the first data.

13. The method of claim 10, further comprising the volatile memory includes an SRAM and a DRAM, which is partitioned to the first memory portion and the second memory portion, the method further comprising:
temporarily storing the first data in the SRAM before the first data are stored in the non-volatile memory based on the physical address of the first data.

14. The method of claim 1, wherein the address mapping data include an L2P table, the method further comprising, by the memory controller:
receiving a second read request for second data, the second read request including a logical address of the second data; and
in response to the second read request:
searching the L2P table based on the logical address of the second data to determine a physical address of the second data; and
extracting the second data from the non-volatile memory based on the physical address of the second data.

15. The method of claim 14, wherein the L2P table of the memory controller includes a directory, a first set of physical block addresses, and a second set of physical block addresses, and wherein the directory and the first set of physical block addresses are stored in the first memory portion, and the second set of physical block addresses is stored in at least one of the second memory portion and the non-volatile memory.

16. The method of claim 1, further comprising:
executing an embedded operating system in the data processor, including performing the plurality of in-memory data processing functions.

17. A memory device, comprising:
a plurality of processor cores;
a volatile memory; and
a non-volatile memory;
wherein the memory device stores one or more programs comprising instructions for:
allocating a first subset of processor cores to perform a plurality of memory access and management functions of a memory controller;
allocating a second subset of processor cores of the memory device to perform a plurality of in-memory data processing functions as a data processor, wherein the plurality of in-memory data processing functions are configured to process, locally on the memory device, data extracted from, or to be stored in, the non-volatile memory;
partitioning the volatile memory to (1) a first memory portion for storing address mapping data temporarily for the memory controller and (2) a second memory portion for storing payload data temporarily for the data processor;
storing the address mapping data used by the memory controller and the payload data used by the data processor separately in the first memory portion and the second memory portion of the volatile memory;
receiving, from the data processor, a caching request for storing target data temporarily; and
in response to the caching request, in accordance with a determination that the second memory portion associated with the data processor has insufficient memory space to store the target data, storing the target data in the first memory portion via the memory controller.

18. The memory device of claim 17, wherein:
the plurality of processor cores are grouped into a plurality of clusters;
the first subset of processor cores of the memory controller correspond to a first set of one or more clusters, and the second subset of processor cores of the data processor correspond to a second set of one or more clusters; and
the memory controller and the data processor share a cluster-level L3 cache.

19. A non-transitory computer readable storage medium storing one or more programs, the one or more programs comprising instructions that, when executed by a memory device having a plurality of processor cores, a volatile memory, and a non-volatile memory, cause the memory device to perform:
allocating a first subset of processor cores to perform a plurality of memory access and management functions of a memory controller;
allocating a second subset of processor cores of the memory device to perform a plurality of in-memory data processing functions as a data processor, wherein the plurality of in-memory data processing functions are configured to process, locally on the memory device, data extracted from, or to be stored in, the non-volatile memory;
partitioning the volatile memory to (1) a first memory portion for storing address mapping data temporarily for the memory controller and (2) a second memory portion for storing payload data temporarily for the data processor;
storing the address mapping data used by the memory controller and the payload data used by the data processor separately in the first memory portion and the second memory portion of the volatile memory;
receiving, from the data processor, a caching request for storing target data temporarily; and
in response to the caching request, in accordance with a determination that the second memory portion associated with the data processor has insufficient memory space to store the target data, storing the target data in the first memory portion via the memory controller.

20. The non-transitory computer readable storage medium of claim 19, wherein:
the plurality of processor cores are grouped into a plurality of clusters;
the first subset of processor cores of the memory controller correspond to a first set of one or more clusters, and the second subset of processor cores of the data processor correspond to a second set of one or more clusters; and
the memory controller and the data processor share a cluster-level L3 cache.
